(19) United States
(12) Patent Application Publication
(10) Pub. No.: US 2009/0112673 A1
(43) Pub. Date: Apr. 30, 2009

(54) RULES AND WORKFLOW PROCESS INTEGRATION

(75) Inventors: Donald J. McCrady, Redmond, WA (US); Kavita Kamani, Issaquah, WA (US); Constantin Mihai, Bellevue, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/925,738

(22) Filed: Oct. 26, 2007

(51) Int. Cl. G06Q 10/00; G06F 7/00

(52) U.S. Cl. 705/8; 705/7

(57) ABSTRACT

In one embodiment, a computer system accesses a workflow activity from among multiple workflow activities in a workflow process within a workflow process framework. The workflow process describes a procedure for performing a piece of functionality. The workflow activity includes workflow rules, where each rule includes at least one condition and at least one workflow rule action for the condition such that when a pre-determined condition state is reached, the appropriate workflow rule action is executed. The computer system includes a workflow activity as the workflow rule action for at least one of the condition states for the rule. The workflow activity includes functionality configured to do a portion of work. The computer system provides functionality that is available to the workflow process framework to the included workflow activity as a result of the workflow activity being included in the workflow rule action.

### BACKGROUND

Computers have become highly integrated in the workforce, in the home, and in mobile devices. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

In some cases, software applications can be used to generate, edit and display data in the form of workflows. Workflows are typically a way to connect discrete units of work to accomplish a goal. Such units of work may be referred to as activities. Activities are units of work that operate cooperatively within a workflow process framework. Workflows may be used by businesses and other entities to describe processes, systems or other information. In some environments, workflows may be referred to as flow diagrams, process flows, flowcharts, models, process diagrams, and/or control charts. In some cases, workflows may be used to illustrate process relationships in a complex business process. These workflows are often referred to as business process flowcharts. In a broader sense, workflows may be used to show any type of relationship information in a process.

Many times, however, software programs configured to process workflows are limited to processing only those activities that are part of the workflow or part of the activity. For example, if one of the workflow's activities includes multiple rules (often referred to as a ruleset), the processing of that activity may be limited to the rules in that activity. Rulesets are typically unable to cause other activities outside of the ruleset to execute. Actions performable by a ruleset are usually limited to small sets of short-running statements such as assigning to a data location, calling a method, or other simple code statements. Accordingly, computer-run software applications used to process workflows may be limited to processing the workflow according to the constraints of the activity and rules within the activity being processed.

### BRIEF SUMMARY

Embodiments described herein are directed to controlling the processing of one or more activities within a workflow process of the workflow process framework. In one embodiment, a computer system accesses a workflow activity from among a plurality of workflow activities in a workflow process within a workflow process framework. The workflow process describes a procedure for performing a piece of functionality. The workflow activity includes one or more workflow rules where each rule includes at least one condition and at least one workflow rule action. The computer system provides the workflow process framework with a granular level of control over each of the workflow activities in the workflow process. The computer system determines that at least one of the workflow rule actions or at least one of the conditions is dependent on an input external to the to the workflow activity that is unavailable at a time of processing. The computer system, based on the determination, temporarily delays processing of the dependent workflow rule action until the input is available.

In another embodiment, a computer system accesses a workflow activity from among a plurality of workflow activities in a workflow process. The workflow process describes a procedure for performing a piece of functionality. The computer system inserts a workflow rule into the accessed workflow activity. The workflow rule includes at least one condition and at least one workflow rule action for each condition. The computer system accesses information defining a function identifier for a rule within the accessed workflow activity. The computer system also incorporates the function identifier in a plurality of rules such that the function identifier can be referred to in each of the plurality of rules.

In another embodiment, a computer system accesses a workflow activity from among a plurality of workflow activities in a workflow process within a workflow process framework. The workflow process describes a procedure for performing a piece of functionality. The workflow activity includes workflow rules, where each rule includes at least one condition and at least one workflow rule action for the condition such that when a pre-determined condition state is reached, the workflow rule action is executed. The computer system includes a workflow activity as the workflow rule action for at least one of the conditions for the rule. The workflow activity includes functionality configured to do a portion of work. The computer system also provides a portion of functionality that is available to the workflow process framework to the included workflow activity as a result of the workflow activity being included in the workflow rule action.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a computer architecture in which embodiments of the present invention may operate including controlling the processing of activities within a workflow process, applying user-defined function identifiers to a plurality of rules and including a workflow activity as a rule action in a rule of a workflow process.

FIG. 2 illustrates a flowchart of an example method for controlling the processing of activities within a workflow process.

FIG. 3 illustrates a flowchart of an example method for applying function identifiers to a plurality of rules.

FIG. 4 illustrates a flowchart of an example method for including a workflow activity as a rule action in a rule of a workflow process.

### DETAILED DESCRIPTION

Embodiments described herein are directed to controlling the processing of one or more activities within a workflow process of the workflow process framework. In one embodiment, a computer system accesses a workflow activity from among a plurality of workflow activities in a workflow process within a workflow process framework. The workflow process describes a procedure for performing a piece of functionality. The workflow activity includes one or more workflow rules where each rule includes at least one condition and at least one workflow rule action. The computer system provides the workflow process framework with a granular level of control over each of the workflow activities in the workflow process. The computer system determines that at least one of the workflow rule actions or at least one of the conditions is dependent on an input external to the to the workflow activity that is unavailable at a time of processing. The computer system, based on the determination, temporarily delays processing of the dependent workflow rule action until the input is available.

In another embodiment, a computer system accesses a workflow activity from among a plurality of workflow activities in a workflow process. The workflow process describes a procedure for performing a piece of functionality. The computer system inserts a workflow rule into the accessed workflow activity. The workflow rule includes at least one condition and at least one workflow rule action for each condition. The computer system accesses information defining a function identifier for a rule within the accessed workflow activity. The computer system also incorporates the function identifier in a plurality of rules such that the function identifier can be referred to in each of the plurality of rules.

In another embodiment, a computer system accesses a workflow activity from among a plurality of workflow activities in a workflow process within a workflow process framework. The workflow process describes a procedure for performing a piece of functionality. The workflow activity includes workflow rules, where each rule includes at least one condition and at least one workflow rule action for the condition such that when a pre-determined condition state is reached, the workflow rule action is executed. The computer system includes a workflow activity as the workflow rule action for at least one of the conditions for the rule. The workflow activity includes functionality configured to do a portion of work. The computer system also provides a portion of functionality that is available to the workflow process framework to the included workflow activity as a result of the workflow activity being included in the workflow rule action.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical storage media and transmission media.

Physical storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry or transport desired program code means in the form of computer-executable instructions or data structures and which can be accessed by a general purpose or special purpose computer. Combinations of the above should also be included within the scope of computer-readable media.

However, it should be understood, that upon reaching various computer system components, program code means in the form of computer-executable instructions or data structures can be transferred automatically from transmission media to physical storage media. For example, computer-executable instructions or data structures received over a network or data link can be buffered in RAM within a network interface card, and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

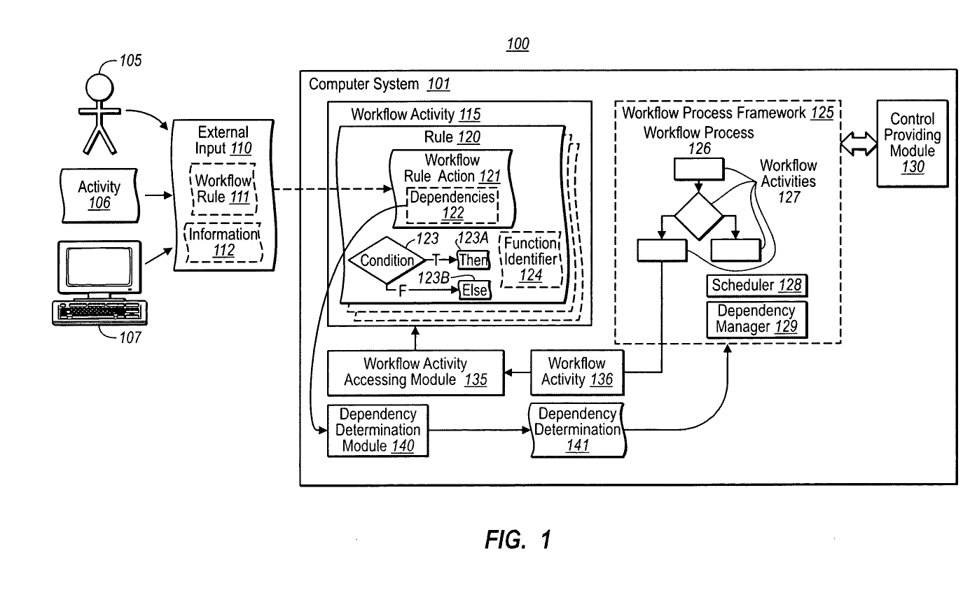

FIG. 1 illustrates a computer architecture 100 in which the principles of the present invention may be employed. Computer architecture 100 includes computer system 101. In some embodiments, computer system may include workflow activity 115. Typically, workflow activities are part of a workflow process (e.g. workflow process 126). Workflow processes may describe any type of process including a business process, configuration process, installation process or any other type of process. Workflow process framework 125 may include scheduler 128, dependency manager 129 and any other items used to provide a framework in which workflow processes can be created, edited, displayed, updated, deleted, stored, transferred or otherwise used.

In some embodiments, computer system 101 may include workflow activity 115, which in turn may contain and control child activities (e.g. any of activities 127) to do portions of its work. Child activities may themselves be comprised of other activities ad-infinitum. Workflow activities 115/127 may perform computations that use and modify variables. Workflow activities may use the surrounding workflow process framework 125, which, in some embodiments, consists of a set of services including, but not limited to, scheduler 128 and dependency manager 129. Workflow activity 115 uses the workflow process framework to execute its child activities. At any point when the workflow process framework 125 determines that the process is waiting for external input, it may use its dependency manager to unload the workflow until such time as that input becomes available, or it may allow other activities to run during the idle time, as will be explained further below. At any point during the workflow's execution, the workflow may receive a “Cancel” request, which will terminate the workflow that is no longer required to run.

In some embodiments, control providing module 130 may provide workflow process framework 125 with a level of control over workflow activities 127. The level of control may be greater or smaller than an existing level of control and may be more or less granular than an existing level of control. For example, control providing module 130 may provide workflow process framework 125 with a greater and more granular level of control over activity 115, for example, such that each condition 123, function identifier 124, rule 120, workflow rule action 121 or dependency 122 may be individually edited, altered or otherwise controlled.

A workflow activity (e.g. workflow activity 115) may be any item configured to perform some piece of functionality or work. For example, an activity may be a code snippet, a script, a file, a software application, or any other means of performing functionality. Such functionality can range from calculating a single value to processing an entire application. In some cases, workflow activities (e.g. 115) may include rules such as rule 120. Rule 120 may be a single rule or may comprise multiple rules, and thus may be referred to as a ruleset. A rule/ruleset may include workflow rule actions 121 which may themselves be activities with rules and rulesets. In some cases, rule 120 may include exactly one condition 123, as well as activities to execute when the condition is true (Then 123A) and activities to execute when the condition is false (Else 123B). Conditions, as used herein, are statements or expressions that include instructions or activities to execute when a particular state is reached. For example, a condition may include a Boolean expression that, when true, the activities listed under Then 123A will be executed and that, when false, the activities listed under Else 133B will be executed. In some cases, these activities are workflow rule actions 121 with dependencies 122.

Dependencies 122 may include any type of dependency on another rule, condition, activity or input. Conditions such as condition 123 may be thought of as being directly dependent on dependencies. For example, a Boolean expression in condition 123 may rely on an external input in determining whether the expression is true or false. Workflow rule actions may thus be thought of as being indirectly dependent on dependencies 122 because the rule actions will not be processed until the external input has been received or made available and the condition preceding the rule action has been satisfied. Thus, workflow rule action 121 may be indirectly dependent on external input 110. The external input may come from a user 105, another activity 106 or another computer system 107. Additionally or alternatively, dependencies 122 may depend on other information not shown in FIG. 1.

Such dependencies may cause scheduler 128 to wait while scheduling processing of activities. For example, scheduler 128 may determine that activities nested under an activity currently being processed that is dependent on an unavailable input cannot be processed. In such cases, scheduler 128 may delay processing of the nested activities until the external input has been received. Additionally or alternatively, scheduler 128 may determine that the activity or rule action may be temporarily unloaded and that processing may be delayed until a later time. Scheduler 128 may further determine that other, nested activities may be processed while the activity waiting on the unavailable external input is temporarily unloaded.

In some cases, a workflow rule action may be another rule, another ruleset or another activity. Thus, activities, rules, conditions and workflow rule actions may be nested within any activity (e.g. activity 115). Rule condition 123 may be expressed against one or more variables and may introduce dependencies upon the variables. The actions of a rule (Then 123A or Else 123B) may have side-effects (i.e. cause changes) on the variables used in the rule condition 123 of the same or another rule to change values. Dependency manager 129 may be configured to manage these dependencies and side effects, causing the affected rules to be re-executed with the new variable values.

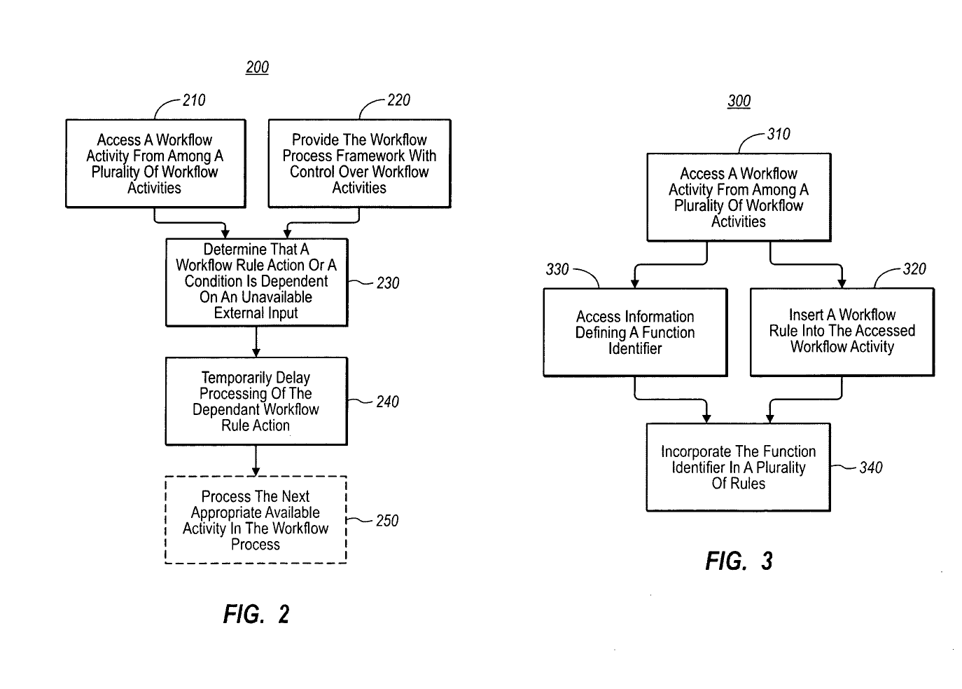

In some cases, workflow activity accessing module 135 may request a workflow activity from workflow process 126. Workflow process framework 125 may send workflow activity 136 to workflow activity accessing module 135 for general accessing. In some cases, workflow activity 115 is the same activity as workflow activity 136. In other cases, workflow activity 115 is a different activity, possibly having been stored earlier by workflow activity accessing module 135. In some instances, workflow activity 115 may be a workflow activity currently being processed by computer system 101. Furthermore, workflow activity 115 may have a rule with a workflow rule action that has an external dependency 122 on which the workflow rule action is waiting. Dependency determination module 140 may be configured to determine that such an external dependency exists and send the dependency determination 141 to workflow process framework 125. Using the dependency determination 141, workflow process framework can make a decision as to how the dependency should be handled if the input is not available. Such a scenario will be described in greater detail below with regard to FIG. 2.

External input 110 may include workflow rule 111 and information 112. In some embodiments, workflow rule 111 may be a rule that is inserted into a workflow activity such as activity 115. Information 112 may be information input by a user to define a function identifier. Function identifiers (e.g. 124) may be any type of reference, moniker, name or other identifier used to identify a rule, a condition, a workflow rule action, or some combination of the three. For example, a user may wish to apply a function identifier to a rule action that performs the function of applying a discount. The user may not know anything about the underlying code that determines whether the discount applies, but the user can simply define a function identifier to refer to the discount functionality.

FIG. 2 illustrates a flowchart of a method 200 for controlling the processing of one or more activities within a workflow process of a workflow process framework. The method 200 will now be described with frequent reference to the components and data of environment 100.

Method 200 includes an act of accessing a workflow activity from among a plurality of workflow activities in a workflow process within a workflow process framework, where the workflow process describes a procedure for performing a piece of functionality, the workflow activity including one or more workflow rules, and where each rule includes at least one condition and at least one workflow rule action (act 210). For example, workflow activity accessing module 135 may access workflow activity 115 from among workflow activities 127 in workflow process 126 within workflow process framework 125. Workflow process 126 may describe a procedure for performing a piece of functionality such as computing a value or processing a portion of software code. In some cases, workflow process 126 may describe a business process. Workflow activity 115 may include one or more workflow rules 120 where each rule includes at least one condition 123 and at least one workflow rule action 121.

As explained above, workflow rule action 121 may include another rule that has at least one condition and at least one workflow rule action. In some cases, workflow rule action 121 may include many additional rules which may be nested down to any reasonable level. Rules, conditions and workflow rule actions may be processed systematically according to states reached at each condition and may as continue in such a manner until each of the nested rules, conditions and/or workflow rule actions has been processed. Rules may also access data using variables, parameters and other data access means.

In some embodiments, a user (e.g. user 105) may be allowed define one or more of the workflow rules. For example, user 105 may desire to create a process- or activity-specific rule that may be inserted into workflow activity 115. The user may generate the rule or, alternatively, may input information 112 which may be used by computer system 101 to generate a rule. Activities may also be defined by user 105. For example, workflow process framework 125 may provide one or more activity templates that allow user 105 to define at least a portion of activity 115. The template may include fields that may be filled in by the user, where each field corresponds to a setting or feature that will be altered based on the user input 110. Thus, in some embodiments, a user may be able to design and implement an activity with process-specific rules with little or no knowledge of the underlying code that actually produces the desired results.

Method 200 includes an act of providing the workflow process framework with a granular level of control over each of the workflow activities in the workflow process (act 220). For example, control providing module 130 may provide workflow process framework 125 with a granular level of control over any of workflow activities 127, 136 and 115. Control providing module 130 may provide detailed control over each element in the workflow process including the activities, rules, conditions, workflow rule actions and dependencies. Thus, workflow process framework 125 may activate/deactivate, enable/disable, bypass/force or otherwise control the processing of any elements within the framework. In some cases, increased control over an activity or rule may allow workflow process framework to debug one or more rules of workflow activity 115. The ability to debug may continue to all or a subset of the rules and/or rulesets in activity 115.

In some cases, changes are made when processing a workflow rule action. For instance, processing workflow rule action 121 according to condition 123 may result in changes to other activities and/or rules. Workflow process framework 125 may be configured to propagate any changes made to workflow rules and/or activities within workflow activity 115 to any rules/activities in other workflow activities that are affected.

Method 200 also includes an act of determining that at least one of the at least one workflow rule actions and the at least one conditions is dependent on an input external to the to the workflow activity that is unavailable at a time of processing (act 230). For example, dependency determining module 140 may determine that either workflow rule action 121 or condition 123 is dependent on an external input 110 that is unavailable at a time of processing by computer system 101. For example, within workflow activity 115, computer system 101 may be processing rule 120 and workflow rule action 121 according to condition 123. Workflow rule action 121 may depend (at least indirectly) on an external input from one or more of any type of external input such as user input, another activity 106 or from another computing system 107. In some cases, the external input may be unavailable (e.g. not yet processed, not yet input, etc.) at the time the rule action is being processed. Thus, dependency determination module 140 may send dependency determination 141 to workflow process framework (which may include a workflow process engine) to determine how to handle the dependency on an unavailable input.

Method 200 includes, based on the determination, an act of temporarily delaying processing of the dependent workflow rule action until the input is available (act 240). For example, based on dependency determination 141, workflow process framework 125 may temporarily delay processing of the dependent workflow rule action until the external input 110 is available. In some cases, the dependent workflow rule action may be temporarily unloaded from computer system memory so that workflow process framework 125 may continue processing other workflow rule actions while waiting for the external input. The dependent workflow rule action may be temporarily unloaded and stored in a persistent storage such as a hard disc or solid state storage device.

Method 200 may also include an act of processing the next appropriate available activity in the workflow process (optional act 250). For example, workflow process framework 125 may determine the next available activity in workflow process 126. In some embodiments, the next available activity may be a rule, a ruleset or a workflow rule action, which may depend on a condition such as condition 123. Workflow process framework 125 may also detect that the temporarily delayed dependent workflow rule action has become available for processing and may process the temporarily delayed dependent workflow rule action.

FIG. 3 illustrates a flowchart of a method 300 for applying function identifiers to a plurality of rules. The method 300 will now be described with frequent reference to the components and data of environment 100.

Method 300 includes an act of accessing a workflow activity from among a plurality of workflow activities in a workflow process, where the workflow process describes a procedure for performing a piece of functionality (act 310). For example, workflow activity accessing module 135 may access workflow activity 136 from among workflow activities 127 in workflow process 126. Workflow process 126 may describe a procedure for performing a piece of functionality such as computing a value or processing a portion of software code.

In some embodiments, workflow process framework 125 may provide one or more activity templates that allow user 105 to define at least a portion of activity 115. The template may include fields that may be filled in by the user, where each field corresponds to a setting or feature that will be altered based on the user input 110. In some cases, a user may be able to specify function identifiers 124 for the user-defined portion of the workflow activity.

Method 300 includes an act of inserting a workflow rule into the accessed workflow activity, the workflow rule including at least one condition and at least one workflow rule action for each condition (act 320). For example, user 105 may insert workflow rule 111 into workflow activity 115, where workflow rule 111 includes at least one condition and at least one workflow rule action for each condition. As described above, workflow rule 111 may also contain multiple workflow rule actions that each have activities and rules of their own. Workflow rule 111 may supplement or overwrite any of rule 120, condition 123 and workflow rule action 121.

Method 300 includes an act of accessing information defining a function identifier for a rule within the accessed workflow activity (act 330). For example, workflow activity 115 may access information 112 defining a function identifier 124 for rule 120 within workflow activity 115. In some cases, the accessed information may be received as external input 110 from user 105. As indicated above, function identifiers (e.g. 124) may be any type of reference, moniker, name or other identifier used to identify a rule, a condition, a workflow rule action, or some combination of the three. For example, a user may wish to apply a function identifier to a rule action that performs the function of applying a discount. The user may not know anything about the underlying code that determines whether the discount applies, but the user can simply define a function identifier to refer to the discount functionality. In some cases, a function identifier created by a user may apply to all the rules of the accessed workflow activity 115. Additionally, the function identifier may apply to one or more rules in a plurality of activities (e.g. to all of activities 127 in workflow process 126).

Method 300 includes an act of incorporating the function identifier in a plurality of rules such that the function identifier can be referred to in each of the plurality of rules (act 340). For example, workflow process framework 125 may incorporate function identifier 124 in a plurality of rules (e.g. 120) such function identifier 124 can be referred to in each of the plurality of rules. Thus, in some cases, in a workflow activity to which the function identifier is extended, user 105 may be able to refer to the function identifier to access the desired functionality referred to by the function identifier. Workflow process framework 125 may also refer to the function identifier in at least one of the plurality of rules to determine which rule to process. The rule referred to by the function identifier may then be processed by workflow process framework.

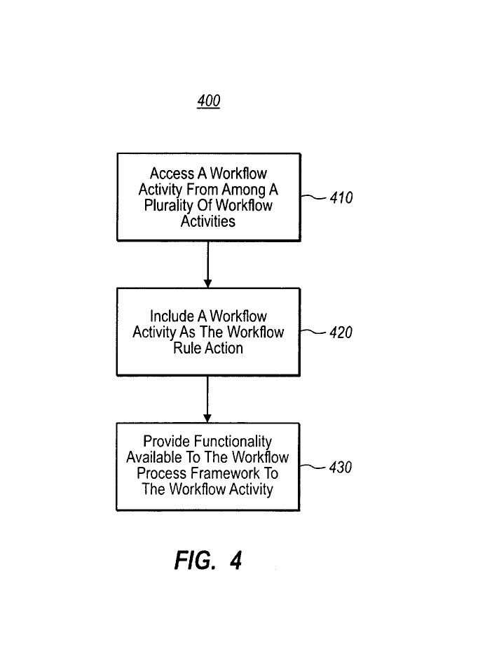

FIG. 4 illustrates a flowchart of a method 400 for including a workflow activity as a rule action in a rule of a workflow process of the workflow process framework. The method 400 will now be described with frequent reference to the components and data of environment 100.

Method 400 includes an act of accessing a workflow activity from among a plurality of workflow activities in a workflow process within a workflow process framework, where the workflow process describes a procedure for performing a piece of functionality, where the workflow activity includes one or more workflow rules, and where each rule includes at least one condition and at least one workflow rule action for the condition such that when a pre-determined condition state is reached, the workflow rule action is executed. For example, workflow activity accessing module may access workflow activity 115 from among workflow activities 127 in workflow process 126 within workflow process framework 125. Workflow process 126 may describe a process for performing a piece of functionality, such as executing a business process. Workflow activity 115 may include one or more workflow rules 120 where each rule includes at least one condition (and in some cases, only one condition) and zero or more workflow rule actions for the condition such that when a pre-determined condition state is reached (e.g. “True” 123A or “False” 123B), the appropriate workflow rule action is executed.

Method 400 also includes an act of including a workflow activity as the workflow rule action for at least one of the condition states for the rule, the workflow activity including functionality configured to do a portion of work. For example, any of workflow activities 127 may be included as the workflow rule action 121 for at least one of the rule condition states 123A or 123B. The workflow activity may include functionality configured to do a portion of work. The included activity may include all or a portion of the elements of workflow activity 115. Indeed, the included activity may include further workflow actions that comprise further activities, ad infinitum. Each may be nested, either individually or as groups, and may nest as far down as desired or as allowed by workflow process framework 125.

Method 400 also includes an act of providing at least a portion of functionality that is available to the workflow process framework to the included workflow activity as a result of the workflow activity being included in the workflow rule action. For example, workflow process framework 125 may provide some functionality that is available to framework 125 to the included workflow activity (e.g. any of activities 127 or child activities of activity 115) as a result of the workflow activity being included in the workflow rule action 121. For example, functionality such as persistence, debugging, cancellation of scheduled activities, access to shared state information, and other functionality. In some embodiments, the included activity may use this added functionality to execute the included activity according to the provided functionality. For instance, the included activity may be able to perform debugging, cancel and/or schedule the processing of other activities, or access shared state information. Thus, because a workflow rule action can be an activity, functionality of the workflow process framework 125 may be shared with the activity.

In some cases, workflow process framework 125 may be configured to display a representation of the provided functionality. In some embodiments, this may comprise displaying a link to added functions or may merely display a list of added functionality now available to the rule action/activity.

Thus, in summary, rule actions may be extended to include multiple activities, each with its own rules, conditions and rule actions. The processing of workflow activities may be controlled at a granular level within a workflow process of a workflow process framework. Function identifiers may be applied to a plurality of rules within a workflow activity, in at least some embodiments of the present invention. And, workflow activities may be included as rule actions in a rule of workflow process within a workflow process framework.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. At a computer system including a workflow process framework, a method for controlling the processing of one or more activities within a workflow process of the workflow process framework, the method comprising:
an act of accessing a workflow activity from among a plurality of workflow activities in a workflow process within a workflow process framework, the workflow process describing a procedure for performing a piece of functionality, the workflow activity comprising one or more workflow rules, each rule including at least one condition and at least one workflow rule action;
an act of providing the workflow process framework with a granular level of control over each of the workflow activities in the workflow process;
an act of determining that at least one of the at least one workflow rule actions and the at least one conditions is dependent on an input external to the to the workflow activity that is unavailable at a time of processing; and
based on the determination, an act of temporarily delaying processing of the dependent workflow rule action until the input is available.

2. The method of claim 1, wherein the act of temporarily delaying processing of the dependent workflow rule action comprises:
an act of unloading the rule action from computer system memory; and
an act of storing the rule action in a persistent storage.

3. The method of claim 1, further comprising an act of processing the next appropriate available activity in the workflow process.

4. The method of claim 1, further comprising allowing a user to define one or more of the workflow rules that comprise other activities.

5. The method of claim 4, further comprising an act of debugging one or more rules of the accessed workflow activity.

6. The method of claim 4, further comprising an act of propagating any changes made to workflow rules in the accessed activity to affected rules in other workflow activities.

7. The method of claim 1, wherein rules access data using at least one of variables and parameters.

8. The method of claim 4, further comprising an act of providing one or more activity templates that allow a user to define at least a portion of an activity.

9. The method of claim 1, further comprising:
an act of detecting that the temporarily delayed dependent workflow rule action is available for processing; and
an act of processing the temporarily delayed dependent workflow rule action.

10. The method of claim 1, wherein the workflow rule action comprises another rule, the rule including at least one condition and at least one workflow rule action.

11. At a computer system including a workflow process framework, a method for applying function identifiers to a plurality of rules, the method including:
an act of accessing a workflow activity from among a plurality of workflow activities in a workflow process, the workflow process describing a procedure for performing a piece of functionality;
an act of inserting a workflow rule into the accessed workflow activity, the workflow rule including at least one condition and at least one workflow rule action for each condition;
an act of accessing information defining a function identifier for a rule within the accessed workflow activity; and
an act of incorporating the function identifier in a plurality of rules such that the function identifier can be referred to in each of the plurality of rules.

12. The method of claim 11, wherein the function identifier applies to all the rules of the accessed workflow activity.

13. The method of claim 11, wherein the function identifier applies to one or more rules in a plurality of activities.

14. The method of claim 11, further comprising an act of providing one or more activity templates that allow a user to define at least a portion of an activity.

15. The method of claim 14, wherein the templates further allow the user to specify function identifiers for the user-defined portion of the activity.

16. The method of claim 11, further comprising:
an act of referring to the function identifier in at least one of the plurality of rules to determine which rule to process; and
an act of processing the rule referred to by the function identifier.

17. At a computer system including a workflow process framework, a method for including a workflow activity as a rule action in a rule of a workflow process of the workflow process framework, the method comprising:
an act of accessing a workflow activity from among a plurality of workflow activities in a workflow process within a workflow process framework, the workflow process describing a procedure for performing a piece of functionality, the workflow activity including one or more workflow rules, each rule including at least one condition and at least one workflow rule action for the condition such that when a pre-determined condition state is reached, the appropriate workflow rule action is executed;
an act of including a workflow activity as the workflow rule action for at least one of the condition states for the rule, the workflow activity including functionality configured to do a portion of work; and
an act of providing at least a portion of functionality that is available to the workflow process framework to the included workflow activity as a result of the workflow activity being included in the workflow rule action.

18. The method of claim 17, further comprising an act of displaying a representation of the provided functionality.

19. The method of claim 17, further comprising an act of executing the included workflow activity according to the provided functionality.

20. The method of claim 17, wherein the condition includes two condition states including a true state and a false state.
